(19) United States
(12) Patent Application Publication
(10) Pub. No.: US 2026/0050355 A1
(43) Pub. Date: Feb. 19, 2026

(54) MULTIPLE SHARED VIEWS FOR COLLABORATION BETWEEN DEVICES

(71) Applicant: Raytheon Company, Tewksbury, MA (US)

(72) Inventors: David James Tomlinson, Laguna Hills, CA (US); Christopher Graham Hoff, Valencia, CA (US); Eric M. Patno, Centerville, UT (US); Christopher Matuszewski, La Mirada, CA (US)

(21) Appl. No.: 18/805,285

(22) Filed: Aug. 14, 2024

(51) Int. Cl. G06F 3/04815; G06F 3/04847; G06F 40/169

(52) U.S. Cl. CPC G06F 3/04815; G06F 3/04847; G06F 40/169

(57) ABSTRACT

A method includes displaying a view of a physical environment on a display of a first electronic device using map data stored locally on the first electronic device. The method also includes receiving a user input comprising at least one annotation for the view. The method further includes displaying a revised view of the physical environment on the display, the revised view comprising the at least one annotation. In addition, the method includes transmitting view information about the revised view to one or more second electronic devices, the view information comprising location information and the at least one annotation without the map data. The transmitted view information is configured to enable the one or more second electronic devices to generate and display the revised view on a corresponding display using second map data stored locally on the one or more second electronic devices.

### TECHNICAL FIELD

This disclosure is generally directed to mobile response efforts in emergency and defense environments. More specifically, this disclosure is directed to techniques for generating multiple shared views for collaboration between devices.

### BACKGROUND

Mobile collaboration systems allow multiple users to share information across multiple devices. These systems can be used in emergency situations, building or area protections, and civil and military applications. In these or other types of situations, shared information can include maps, images of buildings and terrains, and various mobile entities like personnel and vehicles.

### SUMMARY

This disclosure is directed to techniques for generating multiple shared views for collaboration between devices.

In a first embodiment, a method includes displaying a view of a physical environment on a display of a first electronic device using map data stored locally on the first electronic device. The method also includes receiving a user input comprising at least one annotation for the view. The method further includes displaying a revised view of the physical environment on the display, the revised view comprising the at least one annotation. In addition, the method includes transmitting view information about the revised view to one or more second electronic devices, the view information comprising location information and the at least one annotation without the map data. The transmitted view information is configured to enable the one or more second electronic devices to generate and display the revised view on a corresponding display using second map data stored locally on the one or more second electronic devices. The one or more second electronic devices are configured to display the revised view substantially concurrently with the revised view on the first electronic device.

In a second embodiment, an electronic device includes at least one processor configured to control a display to display a view of a physical environment using map data stored locally on the electronic device. The at least one processor is also configured to receive a user input comprising at least one annotation for the view. The at least one processor is further configured to control the display to display a revised view of the physical environment, the revised view comprising the at least one annotation. In addition, the at least one processor is configured to transmit view information about the revised view to one or more second electronic devices, the view information comprising location information and the at least one annotation without the map data. The transmitted view information is configured to enable the one or more second electronic devices to generate and display the revised view substantially concurrently on a corresponding display using second map data stored locally on the one or more second electronic devices.

In a third embodiment, a non-transitory computer readable medium contains instructions that when executed cause at least one processor of an electronic device to control a display to display a view of a physical environment using map data stored locally on the electronic device. The instructions also cause the at least one processor to receive a user input comprising at least one annotation for the view. The instructions further cause the at least one processor to control the display to display a revised view of the physical environment, the revised view comprising the at least one annotation. In addition, the instructions cause the at least one processor to transmit view information about the revised view to one or more second electronic devices, the view information comprising location information and the at least one annotation without the map data. The transmitted view information is configured to enable the one or more second electronic devices to generate and display the revised view substantially concurrently on a corresponding display using second map data stored locally on the one or more second electronic devices.

Any single one or any suitable combination of the following features may be used with the first, second, or third embodiment. The location information may include at least one of: two-dimensional or three-dimensional coordinates, an angle of orientation or rotation, or a zoom level. Second view information may be received from at least one of the one or more second electronic devices, and the second view information may include at least one second annotation. A second revised view of the physical environment may be displayed on the display, and the second revised view may include the at least one second annotation. The one or more second electronic devices may be configured to display the second revised view concurrently with the second revised view on the electronic device or the first electronic device. The at least one annotation and the at least one second annotation may include at least one of: an icon indicating a location of a person or equipment, or one or more drawn lines indicating movement of an object or a plan of future activity. A user actuation of a control on the display of the electronic device or the first electronic device may be received, and the control may be configured to enable the one or more second electronic devices to make changes to the view. Team location information identifying a location of at least one of the electronic device or the first electronic device or the one or more second electronic devices may be received. An icon may be displayed on the view indicating the location of the at least one of the electronic device or the first electronic device or the one or more second electronic devices. The physical environment may be at a location associated with a situation, and the situation may include at least one of: an emergency situation, a search and rescue operation, a natural disaster, an active shooter situation, a military conflict.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system in which generation of multiple shared views for collaboration between devices can be performed according to this disclosure;

FIG. 2 illustrates an example device for generation of multiple shared views for collaboration between devices according to this disclosure;

FIG. 3 illustrates an example system for generation of multiple shared views for collaboration between devices according to this disclosure;

FIGS. 4A and 4B illustrate an example user interface showing a view of a physical environment according to this disclosure;

FIG. 5 illustrates an example framework showing the exchange of information in the system of FIG. 3 according to this disclosure; and

FIG. 6 illustrates an example method for generating multiple shared views for collaboration between devices according to this disclosure.

### DETAILED DESCRIPTION

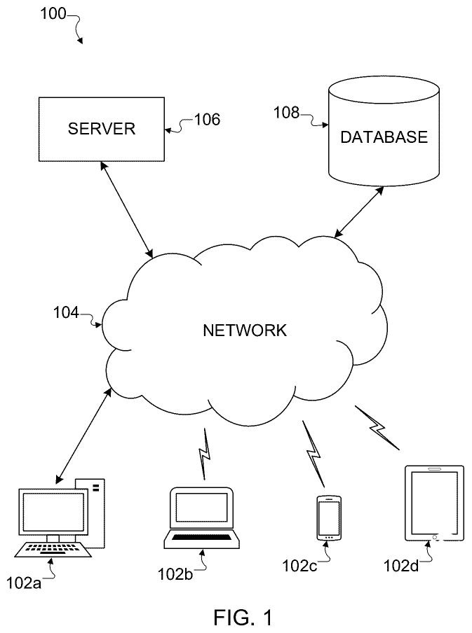

FIGS. 1 through 6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

For simplicity and clarity, some features and components are not explicitly shown in every figure, including those illustrated in connection with other figures. It will be understood that all features illustrated in the figures may be employed in any of the embodiments described. Omission of a feature or component from a particular figure is for purposes of simplicity and clarity and is not meant to imply that the feature or component cannot be employed in the embodiments described in connection with that figure. It will be understood that embodiments of this disclosure may include any one, more than one, or all of the features described here. Also, embodiments of this disclosure may additionally or alternatively include other features not listed here.

As discussed above, mobile collaboration systems allow multiple users to share information across multiple devices. These systems can be used in emergency situations, building or area protections, and civil and military applications. In these or other types of situations, shared information can include maps, images of buildings and terrains, and various mobile entities like personnel and vehicles.

While existing mobile collaboration systems allow for sharing of information between users, these systems are generally limited in their ability to ensure that all users see the same situational awareness views at the same time in order to avoid confusion when collaborating. In particular, these systems are generally limited in controlling who sees what view, how to define the view, and how to restrict and control the view. In many conventional systems, this is achieved through voice communications, and it takes time for everyone to be aligned on what view to be used during collaboration. Also, users can change their local views, which can lead to confusion between users who no longer see the same view. In addition, many of these systems are data-intensive. For example, if a view changes, new map data often needs to be loaded at each user device, which can require significant network bandwidth.

This disclosure provides techniques for generating multiple shared views for collaboration between devices. As discussed in greater detail below, the disclosed embodiments support techniques that ensure all users can see the same view at the same time, e.g., a real-time synchronized view across all user devices, which promotes true collaboration with minimal or no confusion. Also, the disclosed embodiments support optimized data exchange in which only viewing position information (and not whole scene content, map data, and/or geographic data) is exchanged. This allows successful operation in low network bandwidth environments.

FIG. 1 illustrates an example system 100 in which generation of multiple shared views for collaboration between devices can be performed according to this disclosure. As shown in FIG. 1, the system 100 includes multiple user devices 102a-102d, at least one network 104, at least one server 106, and at least one database 108. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the server 106 or database 108 or to receive information from the server 106 or database 108. Example types of information may include sensor readings, angular measurements, and the like.

Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The server 106 is coupled to the network 104 and is coupled to or otherwise communicates with the database 108. The server 106 supports the retrieval of information from the database 108 and the processing of that information. Of course, the database 108 may also be used within the server 106 to store information, in which case the server 106 may store the information itself.

Among other things, the server 106 processes information used in generation of multiple shared views for collaboration between devices. The server 106 includes any suitable structure configured to generate multiple shared views for collaboration between devices. In some embodiments, the server 106 includes one or more processors, one or more memories, and one or more communication interfaces. Note, however, that the server 106 may be implemented in any suitable manner to perform the described functions. Also note that while described as a server here, the device(s) actually implementing the server 106 may represent one or more desktop computers, laptop computers, server computers, or other computing or data processing devices or systems.

The database 108 stores various information used, generated, or collected by the server 106 and the user devices 102a-102d. For example, the database 108 may store map data, annotations, and the like.

There are a number of possible ways to implement the system 100 in order to provide the described functionality for generation of multiple shared views for collaboration between devices. For example, in some embodiments, the server 106 and database 108 are owned, operated, or managed by a common entity. In other embodiments, the server 106 and database 108 are owned, operated, or managed by different entities. Note, however, that this disclosure is not limited to any particular organizational implementation.

Although FIG. 1 illustrates one example of a system 100 for generation of multiple shared views for collaboration between devices, various changes may be made to FIG. 1. For example, the system 100 may include any number of user devices 102a-102d, networks 104, servers 106, and databases 108. Also, while FIG. 1 illustrates that one database 108 is coupled to the network 104, any number of databases 108 may reside at any location or locations accessible by the server 106, and each database 108 may be coupled directly or indirectly to the server 106. In addition, while FIG. 1 illustrates one example operational environment in which generation of multiple shared views for collaboration between devices can be performed, this functionality may be used in any other suitable system.

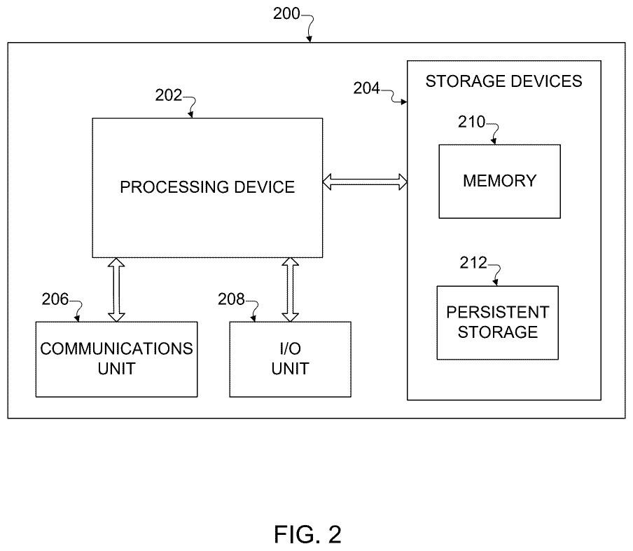

FIG. 2 illustrates an example device 200 for generation of multiple shared views for collaboration between devices according to this disclosure. One or more instances of the device 200 may, for example, be used to at least partially implement the functionality of the server 106 of FIG. 1. However, the functionality of the server 106 may be implemented in any other suitable manner. Also, the same or similar arrangement of components may be used to at least partially implement the functionality of one or more of the user devices 102a-102d in FIG. 1. However, the functionality of each user device 102a-102d may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 can be accessed remotely.

In some embodiments, the instructions executed by the processing device 202 can include instructions that implement the functionality of the server 106 or one or more of the user devices 102a-102d described above. For example, the instructions executed by the processing device 202 can include instructions for generation of multiple shared views for collaboration between devices.

Although FIG. 2 illustrates one example of a device 200 for generation of multiple shared views for collaboration between devices, various changes may be made to FIG. 2. For example, computing devices and systems come in a wide variety of configurations, and FIG. 2 does not limit this disclosure to any particular computing device or system.

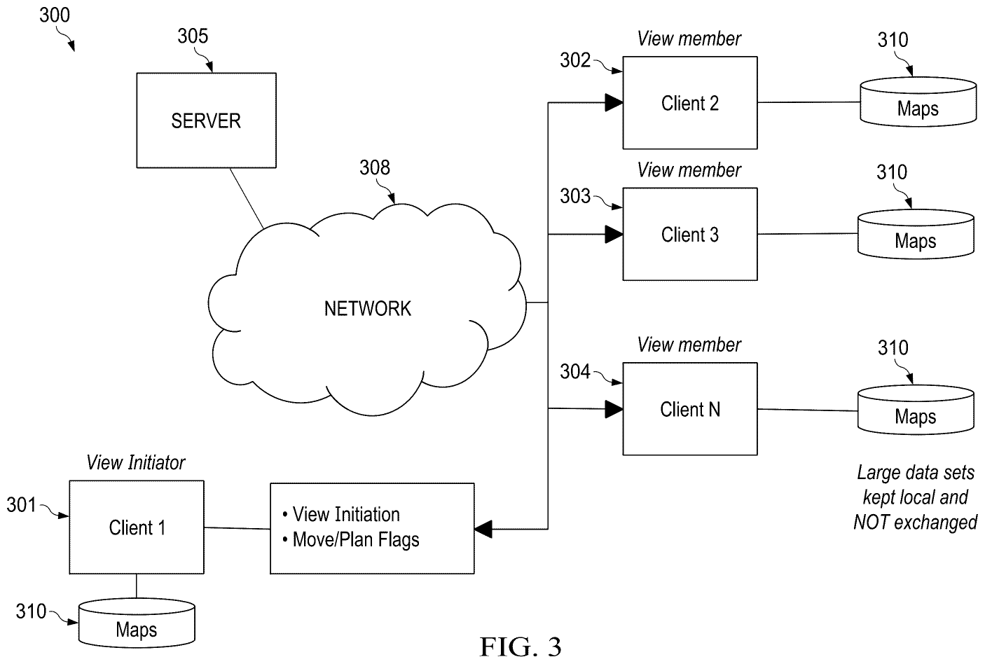

FIG. 3 illustrates an example system 300 for generation of multiple shared views for collaboration between devices according to this disclosure. As shown in FIG. 3, the system 300 includes multiple client devices 301-304 and at least one server 305 that communicate with each other over a network 308. Each client device 301-304 is a user device such as a mobile phone, a tablet, or the like. In some embodiments, each client device 301-304 represents (or is represented by) one of the user devices 102a-102d of FIG. 1. The server 305 supports the exchange of map information and other information that is used in generating multiple shared views for collaboration between devices, and the processing of that information. In some embodiments, the server 305 represents (or is represented by) the server 106 of FIG. 1. The network 308 facilitates communication between various components of the system 300. In some embodiments, the network 308 represents (or is represented by) the network 104 of FIG. 1.

The client devices 301-304 are configured to communicate with each other in support of generating multiple shared views for collaboration between devices. Each client device 301-304 includes a local database 310 that stores map data and other data that can be used in conjunction with generating the shared views. The local database 310 can be preloaded with the map data, which can include photos, schematics, satellite image data, internal building map data, external map data, and the like. As discussed below, having the data preloaded on each client device 301-304 helps in environments where network connectivity is poor or has low bandwidth.

In some embodiments, one client device 301 is designated as a view initiator, and the other client devices 302-304 are designated as view members. Each client device 301-304 is associated with a user or operator, and collectively, the users/operators are members of a team. In some embodiments, the team includes one member designated as a team leader, and the other members of the team are simply referred to as team members. In some embodiments, the team leader is the user of the view initiator (client device 301), while the team members are the users of the view members (client devices 302-304). Additionally or alternatively, one or more of the team members can be the user for the view initiator.

In one aspect of operation, the team leader initiates a view on a display of the client device 301. The view can be a view of a physical environment, such as a location in which there is a situation, such as an emergency situation, a search and rescue operation, a natural disaster, an active shooter situation, a military conflict, or the like. The view is displayed on each of the client devices 301-304 so that the team members can collaborate, such as by coordinating activities and information to address the situation.

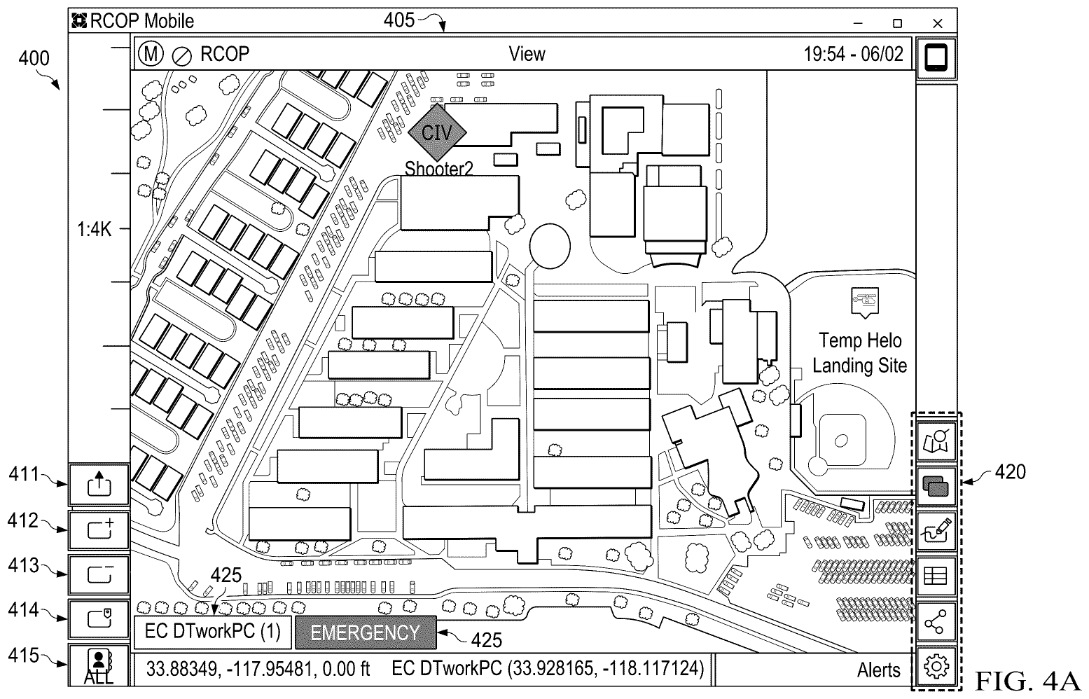

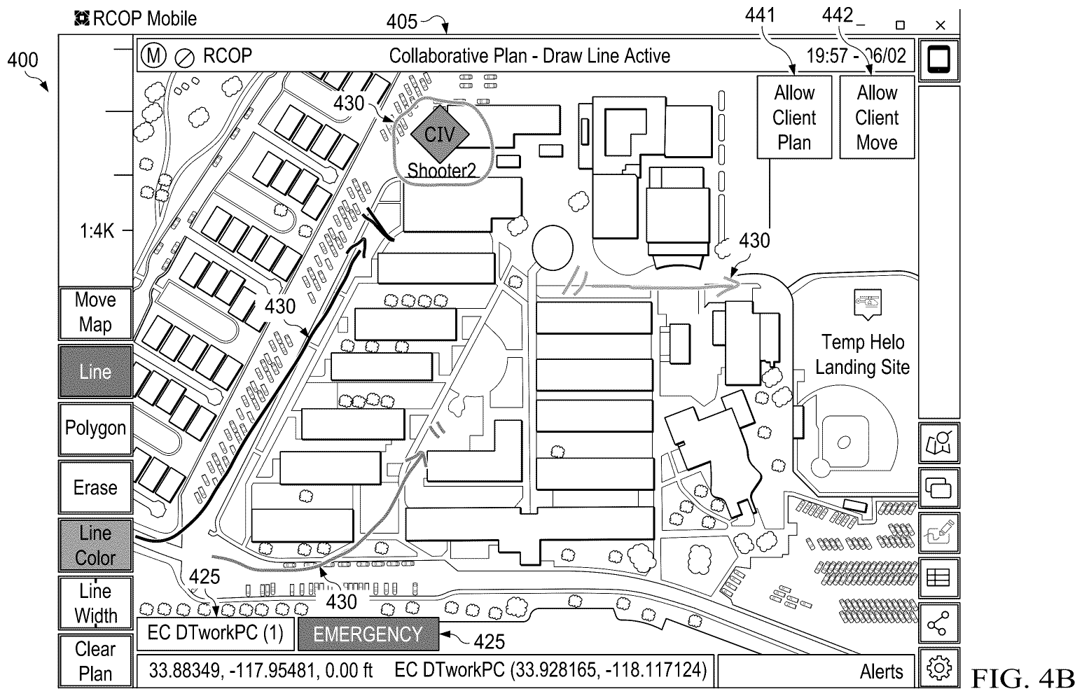

FIGS. 4A and 4B illustrate an example user interface 400 showing a view of a physical environment according to this disclosure. As shown in FIGS. 4A and 4B, the user interface 400 can be a display of each of the client devices 301-304. The user interface 400 shows a view 405 of a physical environment in which a situation is occurring. Here, the view 405 is an aerial view of an urban location that includes multiple buildings, streets, and green spaces. In other examples, the view 405 can include interior views inside a building, elevation views such as a “street view,” or any other suitable view. In FIGS. 4A and 4B, the view 405 is substantially a two-dimensional view. However, in other examples, the view 405 could be a three-dimensional view.

In order for the team members to effectively collaborate, each team member should see the same view 405 on his or her client device 301-304 at substantially the same time. Likewise, any change to the view 405 should be immediately reflected in the displays on each client device 301-304. To improve performance in low bandwidth environments, only limited amounts of data are shared between the client devices 301-304 and the server 305. For example, only the viewing location parameters, annotations, and whiteboarding data need to be communicated between the client devices 301-304. Specific location information that is shared between client devices 301-304 can include view coordinates (such as X-Y coordinates or X-Y-Z coordinates), angle of orientation or rotation, zoom level, and the like.

Large datasets, such as the map data, are stored locally in each database 310 and are not exchanged between the client devices 301-304 in real time. Updates to the large datasets in the database 310 can be obtained from the server 305 or another local map server in real time, during offline or maintenance time periods, or at any other suitable time. Additionally or alternatively, each client device 301-304 can obtain updated map data from another source, such as GOOGLE MAPS.

After the team leader initiates the view 405, the team leader can maintain control of the view 405 at his or her client device 301. As shown in FIG. 4A, the user interface 400 includes multiple view controls 411-415, including a Share View control 411, a Create View control 412, a Delete View control 413, a Group Selection control 414, and a Name Shared View control 415. The Share View control 411 allows the team leader to share a view with team members after the view is created. The Create View control 412 allows the team leader to create a view. The Delete View control 413 allows the team leader to delete a view. The Group Selection control 414 allows the team leader to select multiple objects or annotations within a view. The Name Shared View control 415 allows the team leader to name a view that is shared with the team members.

To initiate the view 405, the team leader can select a location from the map data in the local database 310, display the map data on the user interface 400, and then adjust the view 405, such as by panning to move the view 405, rotating or changing the orientation of the view 405, adjusting the zoom level of the view 405, and the like.

The team leader can also adjust the view 405 to show important details of the situation, in order to improve understanding among the team members. This can include “whiteboarding” or making annotations on the view 405. For example, the team leader can select icons or annotations from a menu of options, or can simply draw or type lines, shapes, text, or the like on the view 405. In some embodiments, the user interface 400 can include multiple view adjustment controls 420 that enable the team leader to adjust the view 405.

FIG. 4B shows the view 405 with various annotations 430 superimposed on the view 405. As shown in FIG. 4B, the annotations 430 can include an icon showing a location of a shooter and various lines drawn by the team leader. Here the lines can indicate movement of personnel, equipment, a plan of future activity, or the like. Other annotations can include pop-up icons, where a user clicks on the icon and a pop-up view appears with additional information.

The view 405 can also include location information of personnel, equipment, etc., that is updated in real time. For example, each team member is using a client device 301-304 with GPS or other location identification information. This information can be shared with the system 300 so that all team members can be identified and shown in their location on the view 405. As a particular example, if a team member's vehicle approaches a building in the view 405, an icon representing the vehicle can be displayed on the view 405 in the same location as the vehicle. Updates can be made frequently (such as two times per second), and the updated information can be broadcast to all team members so that each client device 301-304 displays the updated information in real time.

Once the team leader is satisfied with the view 405, the team leader can share the view with the other team members, such as by clicking on the Share View control 411. Once shared, the view 405 can be displayed identically on each client device 301-304, so that all team members see the same view 405 with the same annotations and markings. Although all team members can see the view 405, the team leader remains in control of view, unless the team leader gives control to one or more team members. For example, in some scenarios, the team leader can allow team members to draw plans or change or move views as needed. As shown in FIG. 4B, the user interface 400 can include a “Allow Client Plan” control 441 that, when actuated, allows other team members to “plan” or change the view 405, such as by drawing lines or creating other annotations. The user interface 400 can also include a “Allow Client Move” control 442 that, when actuated, allows other team members to move the view 405, such as by panning or rotating the view 405. In some embodiments, once the team leader enables controls 441 and/or 442, one or more control options are provided on the team member client devices 302-304, e.g., to allow the team members to plan, change, adjust, and/or move the current view that is shared across the multiple devices. When a team member makes a change to a view, such as by adding another annotation, the revised view is displayed on all of the client devices 301-304 concurrently in real time (i.e., displayed on all client devices 301-304 immediately or as quickly as network and processing latencies allow).

In some embodiments, multiple views 405 can be maintained in the user interface 400 via the use of multiple tabs 425. For example, the team leader can open a new tab 425 at the bottom of the user interface 400 in order to generate a new view 405. The new view 405 can be identical to the previous view 405 except for the annotations, so there is little processing overhead in generating a new view 405. The views 405 use the same map data, so no loading of maps on each view 405 is needed. Each view 405 can be separately shared with team members. Thus, one or more views 405 can be shared, while one or more other views 405 can remain not shared at the same time. Clicking on each tab takes a team member quickly to the view 405 associated with that tab.

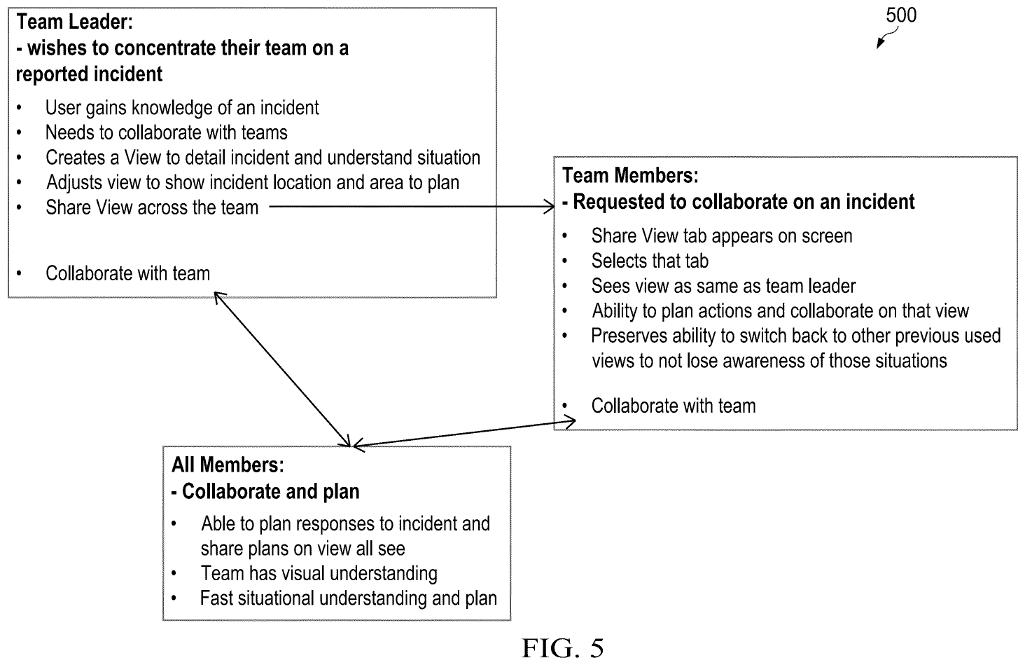

FIG. 5 illustrates an example framework 500 showing the exchange of information in the system 300 according to this disclosure. As shown in FIG. 5, the team leader acts to concentrate their team on a reported incident after the incident becomes known. The team leader can create a view to detail the incident and provide understanding of the incident, such as by displaying annotations on the view. The team leader can adjust the view to show the incident location and one or more areas to plan. The team leader can then share the view with the other team members and collaborate with the team.

The team members are requested by the team leader to collaborate on the incident. Once a team member selects a Share View tab on their screen, that team member can see the same view as the team leader. Each team member can plan actions and collaborate on the view. When there is more than one view (i.e., more than one tab), the team member can switch between views by selecting a tab. When a team member switches back to a previously used view, the situational information in that view is maintained and re-displayed so that the team member does not lose awareness of that situational information.

Although FIGS. 1 through 5 illustrate an example system for generating multiple shared views for collaboration between devices, and related details, various changes may be made to FIGS. 1 through 5. For example, various components shown and described above may be combined, further subdivided, replicated, rearranged, or omitted and additional components may be added according to particular needs. Also, various operations described above could overlap, occur in parallel, occur in a different order, or occur multiple times. Moreover, some operations could be combined or removed and additional steps could be added according to particular needs.

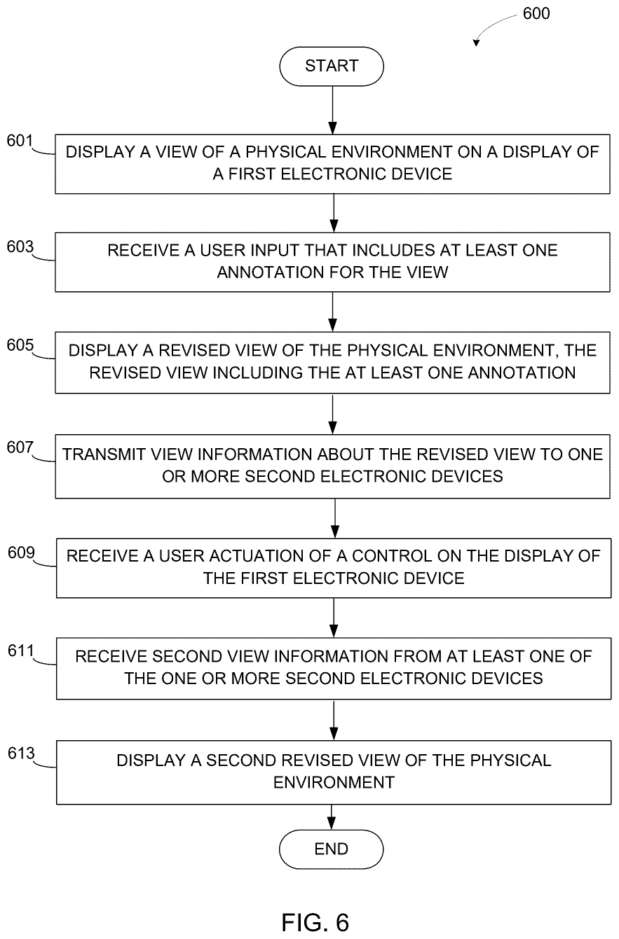

FIG. 6 illustrates an example method 600 for generating multiple shared views for collaboration between devices according to this disclosure. For ease of explanation, the method 600 is described as being performed using the system 300 of FIG. 3. However, the method 600 could be used with any other suitable device or system.

As shown in FIG. 6, at step 601, a view of a physical environment is displayed on a display of a first electronic device using map data stored locally on the first electronic device. This may include, for example, the client device 301 displaying the view 405 on a display that includes the user interface 400 using map data stored in the database 310.

At step 603, a user input is received that includes at least one annotation for the view. This may include, for example, the client device 301 receiving a user input that includes at least one annotation 430 for the view 405.

At step 605, a revised view of the physical environment is displayed on the display, where the revised view includes the at least one annotation. This may include, for example, the client device 301 displaying a revised view 405 of the physical environment on the display, where the revised view 405 includes the at least one annotation 430, such as shown in FIG. 4B.

At step 607, view information about the revised view is transmitted to one or more second electronic devices. The view information includes location information and the at least one annotation. The view information does not include the map data. The transmitted view information enables the one or more second electronic devices to generate and display the revised view on a corresponding display using second map data stored locally on the one or more second electronic devices. The revised view is displayed on the one or more second electronic devices concurrently with the revised view on the first electronic device. This may include, for example, the client device 301 transmitting view information to the client devices 302-304, which allows the client devices 302-304 to display the view 405 using map data stored locally on the corresponding database 310.

At step 609, a user actuation of a control on the display of the first electronic device is received. The control enables the one or more second electronic devices to make changes to the view. This may include, for example, the client device 301 receiving a user input of clicking on one of the controls 441 and 442.

At step 611, second view information is received from at least one of the one or more second electronic devices, where the second view information includes at least one second annotation. This may include, for example, the client device 301 receiving second view information from one or more of the client devices 302-304, where the second view information includes at least one second annotation 430.

At step 613, a second revised view of the physical environment is displayed on the display. The second revised view includes the at least one second annotation. The second revised view is displayed on the one or more second electronic devices concurrently with the second revised view on the first electronic device. This may include, for example, the client device 301 displaying the second revised view 405 including the at least one second annotation 430. The second revised view 405 is also displayed on the client devices 302-304 at the same time.

Although FIG. 6 illustrates one example of a method 600 for generating multiple shared views for collaboration between devices, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
displaying a view of a physical environment on a display of a first electronic device using map data stored locally on the first electronic device;
receiving a user input comprising at least one annotation for the view;
displaying a revised view of the physical environment on the display, the revised view comprising the at least one annotation; and
transmitting view information about the revised view to one or more second electronic devices, the view information comprising location information and the at least one annotation without the map data;
wherein the transmitted view information is configured to enable the one or more second electronic devices to generate and display the revised view on a corresponding display using second map data stored locally on the one or more second electronic devices; and
wherein the one or more second electronic devices are configured to display the revised view substantially concurrently with the revised view on the first electronic device.

2. The method of claim 1, wherein the location information comprises at least one of: two-dimensional or three-dimensional coordinates, an angle of orientation or rotation, or a zoom level.

3. The method of claim 1, further comprising:
receiving second view information from at least one of the one or more second electronic devices, the second view information comprising at least one second annotation; and
displaying a second revised view of the physical environment on the display, the second revised view comprising the at least one second annotation;
wherein the one or more second electronic devices are configured to display the second revised view concurrently with the second revised view on the first electronic device.

4. The method of claim 3, wherein the at least one annotation and the at least one second annotation comprise at least one of: an icon indicating a location of a person or equipment, or one or more drawn lines indicating movement of an object or a plan of future activity.

5. The method of claim 1, further comprising:
receiving a user actuation of one or more controls on the display of the first electronic device, the one or more controls configured to enable the one or more second electronic devices to make changes to the view.

6. The method of claim 1, further comprising:
receiving team location information identifying a location of at least one of the first electronic device or the one or more second electronic devices; and
displaying an icon on the view indicating the location of the at least one of the first electronic device or the one or more second electronic devices.

7. The method of claim 1, wherein the physical environment is at a location associated with a situation, the situation comprising at least one of: an emergency situation, a search and rescue operation, a natural disaster, an active shooter situation, a military conflict.

8. An electronic device comprising:
at least one processor configured to:
control a display to display a view of a physical environment using map data stored locally on the electronic device;
receive a user input comprising at least one annotation for the view;
control the display to display a revised view of the physical environment, the revised view comprising the at least one annotation; and
transmit view information about the revised view to one or more second electronic devices, the view information comprising location information and the at least one annotation without the map data; and
wherein the transmitted view information is configured to enable the one or more second electronic devices to generate and display the revised view substantially concurrently on a corresponding display using second map data stored locally on the one or more second electronic devices.

9. The electronic device of claim 8, wherein the location information comprises at least one of: two-dimensional or three-dimensional coordinates, an angle of orientation or rotation, or a zoom level.

10. The electronic device of claim 8, wherein the at least one processor is further configured to:
receive second view information from at least one of the one or more second electronic devices, the second view information comprising at least one second annotation; and
control the display to display a second revised view of the physical environment, the second revised view comprising the at least one second annotation; and
wherein the one or more second electronic devices are configured to display the second revised view concurrently with the second revised view on the electronic device.

11. The electronic device of claim 10, wherein the at least one annotation and the at least one second annotation comprise at least one of: an icon indicating a location of a person or equipment, or one or more drawn lines indicating movement of an object or a plan of future activity.

12. The electronic device of claim 8, wherein the at least one processor is further configured to receive a user actuation of one or more controls on the display of the electronic device, the one or more controls configured to enable the one or more second electronic devices to make changes to the view.

13. The electronic device of claim 8, wherein the at least one processor is further configured to:
receive team location information identifying a location of at least one of the electronic device or the one or more second electronic devices; and
control the display to display an icon on the view indicating the location of the at least one of the electronic device or the one or more second electronic devices.

14. The electronic device of claim 8, wherein the physical environment is at a location associated with a situation, the situation comprising at least one of: an emergency situation, a search and rescue operation, a natural disaster, an active shooter situation, a military conflict.

15. A non-transitory computer readable medium containing instructions that when executed cause at least one processor of an electronic device to:
control a display to display a view of a physical environment using map data stored locally on the electronic device;
receive a user input comprising at least one annotation for the view;
control the display to display a revised view of the physical environment, the revised view comprising the at least one annotation; and
transmit view information about the revised view to one or more second electronic devices, the view information comprising location information and the at least one annotation without the map data; and
wherein the transmitted view information is configured to enable the one or more second electronic devices to generate and display the revised view substantially concurrently on a corresponding display using second map data stored locally on the one or more second electronic devices.

16. The non-transitory computer readable medium of claim 15, wherein the location information comprises at least one of: two-dimensional or three-dimensional coordinates, an angle of orientation or rotation, or a zoom level.

17. The non-transitory computer readable medium of claim 15, further containing instructions that when executed cause the at least one processor to:
receive second view information from at least one of the one or more second electronic devices, the second view information comprising at least one second annotation; and
control the display to display a second revised view of the physical environment, the second revised view comprising the at least one second annotation; and
wherein the one or more second electronic devices are configured to display the second revised view concurrently with the second revised view on the electronic device.

18. The non-transitory computer readable medium of claim 17, wherein the at least one annotation and the at least one second annotation comprise at least one of: an icon indicating a location of a person or equipment, or one or more drawn lines indicating movement of an object or a plan of future activity.

19. The non-transitory computer readable medium of claim 15, further containing instructions that when executed cause the at least one processor to receive a user actuation of one or more controls on the display of the electronic device, the one or more controls configured to enable the one or more second electronic devices to make changes to the view.

20. The non-transitory computer readable medium of claim 15, further containing instructions that when executed cause the at least one processor to:
receive team location information identifying a location of at least one of the electronic device or the one or more second electronic devices; and
control the display to display an icon on the view indicating the location of the at least one of the electronic device or the one or more second electronic devices.
